(19) United States
(12) Patent Application Publication
(10) Pub. No.: US 2007/0071964 A1
(43) Pub. Date: Mar. 29, 2007

(54) Nano-particle device and method for manufacturing nano-particle device

(75) Inventor: Suguru Noda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JAPAN SCIENCE AND TECHNOLOGY AGENCY, Kawaguchi-shi, Saitama (JP)

(21) Appl. No.: 10/569,446

(22) PCT Filed: Aug. 26, 2004
(86) PCT No.: PCT/JP04/12261

§ 371 Date: Oct. 24, 2006

(30) Foreign Application Priority Data
Aug. 29, 2003 (JP) 2003-306045
Mar. 31, 2004 (JP) 2004-105046

(51) Int. Cl. B32B 5/16; C22F 1/10

(52) U.S. Cl. 428/323; 148/527

(57) ABSTRACT

A nanoparticle device that can be arranged at high density and a method for producing the nanoparticle device are provided. An underlying microcrystalline film (2) is formed on a substrate (1) by non-epitaxial growth. The lattice constants of the material for this underlying microcrystalline film (2) and a nanoparticle material (4) are matched. The surface of each underlying microcrystal in the underlying microcrystalline film (2) is used as a very small space. The nanoparticle material (4) is grown on the underlying microcrystal by local epitaxy to produce a nanoparticle in the very small space.

### TECHNICAL FIELD

The present invention relates to a nanoparticle device and a method for manufacturing the nanoparticle device. In particular, the present invention relates to a perpendicular magnetic recording medium for use in a hard disk in which a high-density array is indispensable.

### BACKGROUND ART

Major terms used in the present invention are explained below.

The term “FePt” refers to an Fe/Pt alloy having an element ratio of about 1:1. An Fe/Pt alloy having an fct crystal structure can have a strong magnetic anisotropy.

The term “fct” phase stands for “face centered tetragonal” phase. An fct phase in FePt essentially has the same configuration as an fcc phase but has a structure in which Fe atoms and Pt atoms are alternately present in a c-axis direction (<001> direction). This structure is called L1₀. While the fct phase is stable at normal temperature and pressure, the fcc phase tends to occur by a common production method. The fct phase often occurs in deposition at high temperature or in annealing and slow cooling.

The term “fcc” phase stands for “face centered cubic.” The fcc phase tends to occur in FePt. Fe atoms and Pt atoms are randomly located at atomic positions of the fcc phase. Furthermore, the fcc phase characteristically has no magnetic anisotropy.

The term “c-axis orientation” refers to a state in which a plurality of crystallites is aligned in a <001> direction. The c-axis orientation is very important when an fct-FePt, which has magnetic anisotropy in a c-axis direction, is applied to a perpendicular magnetic recording medium.

The term “out-of-plane orientation” refers to the regularity of crystal orientation in a direction perpendicular to a substrate. Even in non-epitaxial growth, the out-of-plane orientation may occur at a minimum surface energy, a minimum chemical etching rate, a minimum plasma irradiation damage, or a minimum stress, or in a competing process between orientations of different growth rates.

The term “in-plane orientation” refers to the regularity of crystal orientation in a direction parallel to a substrate. Non-epitaxial growth on a smooth substrate has no mechanism for promoting the in-plane orientation and therefore has no in-plane orientation.

The term “grain growth” refers to a process in which a crystal grows while incorporating surrounding crystals or amorphous phases. The grain growth is remarkable at high temperature and is one of major obstacles to the formation of an FePt microstructure. The process temperature normalized to the melting point can be a measure of the grain growth. Use of material having a higher melting point can reduce the grain growth even at a certain high temperature.

One mechanism of the crystal orientation alignment in the non-epitaxial growth comprises a process of minimizing the energy of a system in order that the structure of the system approaches an equilibrium. When the strain is negligible, the internal energy of a crystallite is independent of the orientation. Therefore, the crystal orientation tends to align at such direction that the surface energy is minimized. This is referred to as “orientation at a minimum surface energy.” This corresponds to a closest packed face of the crystal structure.

The term “heteroepitaxy” refers to the growth of two different crystals while their orientations relative to each other remain unchanged. The heteroepitaxy has been studied actively in various applications, including the quantum dot.

Conventionally, the most widespread method for producing a nanoparticle array on a substrate to achieve a nanodevice is heteroepitaxial growth on a single crystal substrate. A crystal having a specific orientation relative to a single crystal substrate is grown by depositing a raw material slowly on the single crystal substrate under ultrahigh vacuum. Appropriate designing of lattice constants for the single crystal substrate and a layer of interest can produce a nanoparticle structure. This method is being used to develop various materials, such as a quantum dot laser and a magnetic recording medium.

The conventional method for producing a nanoparticle array on a substrate, however, has problems in that the particle size is not always controlled successfully, the cost for production process and a single crystal substrate are expensive, and there are many restrictions on the combination of a layer of interest and a substrate.

Patent Document 1 discloses a technique of controlling the crystal grain size of a magnetic material and the distance between crystal grains utilizing phase separation between the magnetic material and an oxide. In this technique, after a nonmagnetic underlying layer of an hcp structure is formed on a nonmagnetic substrate, a magnetic alloy containing Co and Pt and a nonmagnetic oxide are simultaneously provided on the nonmagnetic underlying layer by sputtering. This is a low-temperature manufacturing technique that assumes the use of a plastic resin. As this is a low-temperature process, a CoPt or an FePt alloy of an fct structure cannot be prepared and large magnetic coercivity cannot be expected. Although a higher process temperature is necessary to the preparation of an alloy having an fct structure, a higher process temperature makes it difficult to control the crystal grain size of the alloy. In addition, the nonmagnetic underlying layer of an hcp structure tends to have an out-of-plane orientation of (001) with a sixfold symmetry, and the alloy of an fct structure on the nonmagnetic underlying layer tends to have an out-of-plane orientation of (111). Thus, the out-of-plane c-axis orientation, that is, (001) orientation necessary for the perpendicular magnetic recording medium is difficult to achieve.

Patent Document 1: Japanese Patent Application Publication No. 2003-178413.

### DISCLOSURE OF INVENTION

In the non-epitaxial growth, the shape, the crystal structure, and the orientation of a deposition layer depend largely on growth conditions. A microcrystalline film having a controlled out-of-plane orientation can be prepared; for example, the film orients into a plane having a minimum surface energy when a thin film is grown on a substrate on which the film can wet, or into a highly resistant plane against plasma irradiation when plasma irradiation is applied during deposition. The crystal size depends on the relationship between the melting point and the process temperature. In combination with lowering of the melting point in a nano-region, a microcrystal having a size of about 10 nm is produced easily. The microcrystalline film has no in-plane orientation.

The present invention relates to a method for using a microcrystalline film prepared by the non-epitaxial growth, utilizing individual surfaces of the microcrystals as a very small space, and producing a nanoparticle in each very small space.

In other words, a nanoparticle can be grown by local epitaxy on each underlying microcrystal by designing the underlying microcrystal and a nanoparticle material to have a comparable lattice constant. Since the in-plane orientation is different between microcrystals, a nanoparticle is difficult to grow over multiple microcrystals. Thus, the present invention utilizes the fact that one nanoparticle can be grown on one underlying microcrystal. Since the underlying microcrystal has an out-of-plane orientation, a nanoparticle also has an out-of-plane orientation.

Examples of a method for stacking nanoparticles include (1) a method for controlling the crystalline orientation using a polycrystalline seed layer as a non-epitaxy technique. This method is sometimes combined with the preparation of a multilayer structure and a phase separation technique. This method is practically the most widespread method because of its low cost but has a poor controllability. That is, the size, the number density, and the interval of crystals are controlled by trial and error. (2) An epitaxy technique requires an expensive single crystal substrate and is not flexible in selecting a material. Furthermore, the epitaxy technique has poor size controllability. (3) A method of applying and aligning colloidal particles has difficulty in controlling a crystal phase and crystalline orientation, thus exhibiting low uniformity in a large area.

In view of the situations described above, it is an object of the present invention to provide a nanoparticle device that can be arranged at high density and a method for manufacturing the nanoparticle device.

The present invention has the following features to achieve the object.

[1] A nanoparticle device includes a monolayer or multilayer substrate, an out-of-plane oriented underlying microcrystalline film deposited on this substrate and having no in-plane orientation, and a nanoparticle formed by local epitaxy on each underlying microcrystal in the underlying microcrystalline film.

[2] A nanoparticle device includes a monolayer or multilayer substrate, an out-of-plane oriented underlying microcrystalline film deposited on this substrate and having no in-plane orientation, a microcrystalline film composed of microcrystals formed by local epitaxy on their respective underlying microcrystals of this underlying microcrystalline film, and a nanoparticle formed by local epitaxy on each microcrystal of this microcrystalline film.

[3] A nanoparticle device includes a monolayer or multilayer substrate, an out-of-plane oriented underlying microcrystalline film deposited on this substrate and having no in-plane orientation, a nanoparticle formed by local epitaxy on each underlying microcrystal in the underlying microcrystalline film, a microcrystalline film formed by local epitaxy on each nanoparticle, and stacked nanoparticles formed by repeated local epitaxy of the nanoparticles and the microcrystalline films in a direction perpendicular to the substrate.

[4] A nanoparticle device includes a monolayer or multilayer substrate, an out-of-plane oriented underlying microcrystalline film deposited on this substrate and having no in-plane orientation, vertically elongated nanoparticles formed by local epitaxy on each underlying microcrystal in the underlying microcrystalline film, and a microcrystalline material formed by local epitaxy on each nanoparticle and surrounding the nanoparticle.

[5] A nanoparticle device includes a monolayer or multilayer substrate, an out-of-plane oriented underlying microcrystalline film deposited on this substrate and having no in-plane orientation, vertically elongated nanoparticles formed by local epitaxy on each underlying microcrystal in the underlying microcrystalline film, and a material that fills the space among the nanoparticles and has a different composition from the nanoparticle.

[6] The nanoparticle device according to [3], [4], or [5] further includes a microcrystalline film that is disposed between the underlying microcrystalline film and the nanoparticle and is composed of microcrystals formed by local epitaxy on their respective underlying microcrystals in the underlying microcrystalline film.

[7] The nanoparticle device according to any one of [1] to [6], wherein the multilayer substrate is formed of a magnetic control layer and/or a structure control layer.

[8] The nanoparticle device according to [7], wherein the structure control layer is not epitaxial with microcrystals of the underlying microcrystalline film.

[9] The nanoparticle device according to [8], wherein a layer that is not epitaxial with microcrystals of the underlying microcrystalline film is formed of an amorphous substance.

[10] The nanoparticle device according to [9], wherein the amorphous substance contains at least one element selected from the group consisting of C, N, O, Al, and Si.

[11] The nanoparticle device according to [8], wherein the layer that is not epitaxial with microcrystals of the underlying microcrystalline film is formed of a crystal with a large lattice mismatch.

[12] The nanoparticle device according to [8], wherein a layer that is not epitaxial with microcrystals of the underlying microcrystalline film is formed of a crystal having a disordered surface structure.

[13] The nanoparticle device according to any one of [1] to [6], wherein the underlying microcrystalline film is formed of a high-melting point material.

[14] The nanoparticle device according to [13], wherein the high-melting point material is a NaCl-type crystal.

[15] The nanoparticle device according to [14], wherein the NaCl-type crystal is a nitride.

[16] The nanoparticle device according to [15], wherein the nitride is TiN, VN, ZrN, NbN, HfN, TaN, or ThN.

[17] The nanoparticle device according to [13], wherein the NaCl-type crystal is an oxide.

[18] The nanoparticle device according to [17], wherein the oxide is MgO, CaO, SrO, or BaO.

[19] The nanoparticle device according to [13], wherein the high-melting point material includes Ti, V, Zr, Nb, Mo, Hf, Ta, and/or W.

[20] The nanoparticle device according to any one of [1] to [6], wherein the nanoparticle is formed of a magnetic recording material.

[21] The nanoparticle device according to [20], wherein the magnetic recording material is an alloy having an L1₀ structure.

[22] The nanoparticle device according to [21], wherein the alloy having an L1₀ structure is an fct transition metal/noble metal alloy.

[23] The nanoparticle device according to [22], wherein the fct transition metal/noble metal alloy is FePt or CoPt.

[24] The nanoparticle device according to [3] or [4], wherein the microcrystal formed by local epitaxy on each nanoparticle is formed of a metal or alloy material containing Ti, Fe, Co, Cr, Ag, and/or Pt.

[25] The nanoparticle device according to [5], wherein the material different from a component of the nanoparticle is an amorphous material containing at least one element selected from the group consisting of C, N, O, Al, and Si.

[26] The nanoparticle device according to [5], wherein the material different from a component of the nanoparticle is a metal or alloy material containing Ti, Fe, Co, Cr, Ag, and/or Pt.

[27] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, and using the surface of each underlying microcrystal in the underlying microcrystalline film as a very small space for local epitaxial growth on the underlying microcrystal to produce a nanoparticle in the very small space.

[28] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, and alternately depositing the nanoparticle material and a material, including the underlying material, that has a comparable lattice constant to the nanoparticle material on the nanoparticle in a direction perpendicular to the substrate to stack the nanoparticles by local epitaxial growth.

[29] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, depositing a material that has a different composition from the nanoparticle and has a comparable lattice constant to the nanoparticles, and segregating the material to be epitaxial with the nanoparticle, and simultaneously or alternately depositing the nanoparticle material and a material that has a different composition from the nanoparticle and has a comparable lattice constant to the nanoparticle to grow the nanoparticle in a direction perpendicular to the substrate.

[30] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, depositing a material having a different composition from the nanoparticle to be distributed by segregation among the nanoparticles, and simultaneously or alternately depositing the nanoparticle material and the material having a different composition from the nanoparticle to grow the nanoparticle in a direction perpendicular to the substrate.

[31] The method for producing a nanoparticle device according to any one of [27] to [30] further includes the step of forming a microcrystalline film composed of microcrystals formed by local epitaxy on their respective underlying microcrystals in the underlying microcrystalline film between the step (a) and the step (b).

[32] The method for producing a nanoparticle device according to any one of [27] to [31], wherein grain growth in the underlying microcrystalline film is suppressed and the underlying microcrystalline film is out-of-plane oriented at a minimum surface energy, a minimum chemical etching rate, a minimum plasma irradiation damage, a minimum stress, or a maximum growth rate.

[33] The method for producing a nanoparticle device according to any one of [27] to [32], wherein the nanoparticle is an FePt-based magnetic nanoparticle.

[34] The method for producing a nanoparticle device according to any one of [27] to [32], wherein the nanoparticle is a CoPt-based magnetic nanoparticle.

[35] The method for producing a nanoparticle device according to [33] or [34], wherein the local epitaxial growth is performed while the substrate is heated at 200° C. to 1600° C.

[36] The method for producing a nanoparticle device according to [35], wherein the local epitaxial growth is performed by forming the underlying microcrystalline film and then depositing FePt or CoPt without exposure to the atmosphere.

[37] The method for producing a nanoparticle device according to [33] or [34], wherein the underlying microcrystalline film is deposited on the substrate and then FePt or CoPt is deposited and is annealed at 200° C. to 1600° C. to perform local epitaxial growth.

[38] The method for producing a nanoparticle device according to [37], wherein after the formation of the underlying microcrystalline film FePt or CoPt is deposited without exposure to the atmosphere and is then annealed to perform local epitaxial growth.

[39] The method for producing a nanoparticle device according to any one of [27] to [38], wherein the crystal structure of the nanoparticle is an fct structure and at least 90% of the c-axis of the crystal of the nanoparticle becomes oriented in a direction perpendicular to the underlying microcrystalline film.

### BRIEF DESCRIPTION OF THE DRAWINGS

FIG. 1 is a manufacturing process drawing of a nanoparticle device according to a first embodiment of the present invention.

FIG. 2 is a schematic view of the orientation of an underlying film.

FIG. 3 is a graph showing metallic elements of a material for an underlying film.

FIG. 4 is a schematic view of an fct crystal structure of an FePt magnetic substance.

FIG. 5 is a schematic view of metal nitrides of NaCl-type TiN and TaN as underlying films.

FIG. 6 is electron micrographs showing specific examples of the formation of FePt magnetic nanoparticles on an underlying film.

FIG. 7 is cross-sectional transmission electron microscope images of monolayer nanoparticles.

FIG. 8 is a graph showing the magnetic characteristics (magnetization as a function of magnetic field) of the monolayer nanoparticles in FIG. 7.

FIG. 9 is a graph showing the magnetic characteristics (magnetization as a function of magnetic field) of monolayer nanoparticles as a comparative example.

FIG. 10 is a manufacturing process drawing of a laminated nanoparticle device according to a second embodiment of the present invention.

FIG. 11 is a cross-sectional transmission electron microscope image of a laminated nanoparticle device according to a second embodiment of the present invention.

FIG. 12 is a manufacturing process drawing of a nanoparticle device including vertically elongated nanoparticles according to a third embodiment of the present invention.

FIG. 13 is a manufacturing process drawing of a nanoparticle device including vertically elongated nanoparticles according to a fourth embodiment of the present invention.

FIG. 14 is a schematic view of the structure of a nanoparticle device according to a fifth embodiment of the present invention.

FIG. 15 is a schematic view of the structure of a nanoparticle device including stacked FePt nanoparticles according to a sixth embodiment of the present invention.

FIG. 16 is a schematic view of the structure of a nanoparticle device including vertically elongated nanoparticles according to a seventh embodiment of the present invention.

### BEST MODE FOR CARRYING OUT THE INVENTION

According to the present invention, the following effects can be achieved.

(1) The process is a dry process. A nanoparticle can be decreased to about 3 to 10 nm in size. Thus, electronic, magnetic, and optical microdevices including nanoparticles, such as a semiconductor quantum dot device, can be manufactured.

(2) A substrate and an underlying microcrystalline film are in a non-epitaxial relationship. Thus, a substrate can be selected flexibly and an inexpensive substrate can be utilized. The process may be a dry process, which can have uniformity in a large area and cut down on costs, such as a sputtering method.

(3) According to the present invention, the recording density of an FePt-based perpendicular magnetic recording medium, which is expected to be a next-generation recording medium, can be increased by one or two orders of magnitude relative to that of the existing hard disk.

In other words, a nanoparticle after synthesis generally has an fcc crystal structure. Thus, to generate a large magnetic anisotropy energy, the process temperature must be increased to achieve an fct structure. However, particles generally tend to aggregate at higher temperature and therefore particles having a size of about 10 nm cannot be prepared. According to the present invention, since an underlying microcrystalline film is formed of a high-melting point material, particles hardly grow and can retain a crystal grain size of about 10 nm. In addition, an FePt-based material grows on each individual underlying crystal. Thus, the nanoparticle having a size of about 10 nm and having an fct structure can be prepared. Desirably, the processing temperature is 200° C. to 1600° C. and particularly is 300° C. to 800° C.

(4) A magnetic recording medium has a problem of magnetic interference between nanoparticles. According to the present invention, the in-plane number density of nanoparticles and the volume of a nanoparticle are independently controlled by the crystal number density of an underlying microcrystalline film and the amount of an FePt-based material to be deposited, respectively. Thus, the distance between nanoparticles can be controlled to an appropriate distance of a few nanometers. This can suppress the magnetic interference between nanoparticles, keeping the magnetic domain size, that is, the size of 1 bit small.

(5) Local epitaxy with an oriented underlying microcrystalline film allows at least 90% of the c-axis of a nanoparticle crystal to become oriented in a direction perpendicular to a substrate, thus providing a high-density perpendicular magnetic recording medium.

(6) Application to the magnetic recording medium is an example. Control of nanoparticle structures, such as the size, the interval, and the orientation, using an underlying microcrystalline film allows functions of structure control to be shared.

(7) Manufacturing cost can greatly be reduced as compared with a conventional epitaxy method, which requires an expensive single crystal substrate.

(8) Advanced structure control (in the existing non-epitaxy, the size, the number density, and the interval of nanocrystals are controlled by trial and error) can be performed.

The best mode for practicing the present invention will be described below.

(1) Preferably, an underlying microcrystalline film on a substrate in a nanoparticle device is formed of a material that makes the surface energy of a plane epitaxial to an FePt (001) plane minimum. To this end, the material is preferably a NaCl-type crystal in which a plane having a minimum surface energy, that is, a closest packed face has a fourfold symmetry as with the FePt (001) plane, and is more preferably a stable nitride film having a high melting point. For the epitaxial growth of the FePt (001) plane, rather than an FePt (100) plane, on the underlying microcrystalline film, TiN having a relationship of c<a<x<1.1a is more preferable, where x denotes the lattice constant of the underlying NaCl-type crystal, and a and c denote the lattice constant of FePt.

(2) Preferably, an underlying microcrystalline film on a substrate in a nanoparticle device is formed of a high-melting point oxide that has a plane of a minimum surface energy with a fourfold symmetry as in the FePt (001) plane. More preferably, the underlying microcrystalline film is formed of MgO having a lattice constant of c<a<x<1.1a relative to FePt.

(3) TiN and MgO in (1) and (2) have a lattice mismatch of a little over 9% for the lattice constant a of FePt. Local epitaxy of FePt/a microcrystalline film (intermediate layer)/an underlying microcrystalline film in which the intermediate layer is formed of a material having an intermediate lattice constant between that of the underlying microcrystalline film and that of FePt can increase the controllability of an FePt nanoparticle. For example, the material may be Ag (0.4087 nm) and Pt (0.3924 nm) both having an fcc crystal. Fe having a bcc crystal (0.2867 nm) and acting as a lattice of 0.4055 nm when shifted by 45° is also preferred.

Furthermore, an underlying microcrystalline film on a substrate in a nanoparticle device may be a metal film of a high-melting point material.

(4) An FePt (or CoPt) nanoparticle is grown on the underlying microcrystalline film under appropriate substrate heating conditions. The grown nanoparticle is annealed in an appropriate manner. This means annealing including all of the film formation by substrate heating, heating after the film formation, and the film formation by substrate heating and subsequent heating.

### Embodiments

Embodiments of the present invention will be described in detail below.

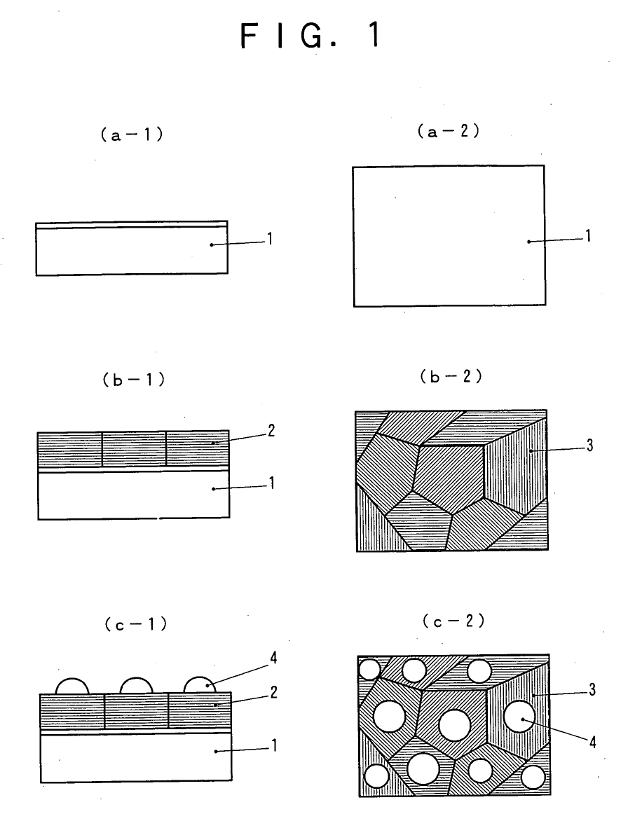

FIG. 1 is a manufacturing process drawing of a nanoparticle device according to a first embodiment of the present invention.

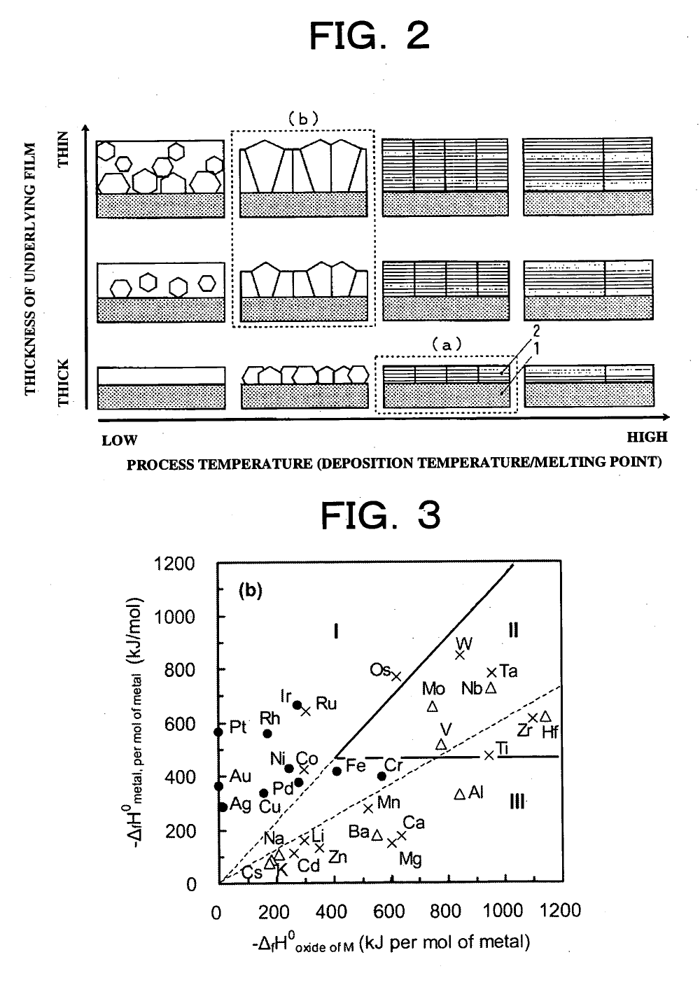

(1) First, as illustrated in FIG. 1(a-1) (cross-sectional view) and FIG. 1(a-2) (plan view), a Si substrate or a SiO₂-coated Si substrate 1 is prepared. A glass substrate is preferred because of its low price.

(2) Then, as illustrated in FIG. 1(b-1) (cross-sectional view) and FIG. 1(b-2) (plan view), a film (underlying film) 2 of a high-melting point material, for example, a TiN material is formed on the SiO₂-coated Si substrate 1 by sputtering. The high-melting point material, for example, TiN characteristically grows to several nanometers even near room temperature but does not grow excessively even at high temperature. The high-melting point material is oriented in the out-of-plane direction to have a minimum surface energy and is not oriented in the in-plane direction. The resulting film (underlying microcrystalline film) 2 is used as an underlying film.

FIG. 2 is a schematic view illustrating the orientation of the underlying film 2. The horizontal axis represents the process temperature (deposition temperature/melting point) and the vertical axis represents the thickness of the underlying film. According to the present invention, the orientation proceeds such that the surface energy controlled by an equilibrium theory is minimized, as illustrated in FIG. 2(a). In other words, the orientation control of the underlying film 2 according to the present invention is performed such that the orientation conforms to the surface to provide a smooth surface and a minimum surface energy, as illustrated in FIG. 2(a). FIG. 2(b) illustrates evolutionary selection growth. Although a kinetically fast growing plane is oriented, bumps and dips are formed. Thus, it is not preferred as the orientation of the underlying film 2 of the present invention.

In other words, the orientation as illustrated in FIG. 2(a) can reduce the bumps and dips on the entire underlying film 2 to less than several nanometers.

In addition to TiN shown in FIG. 1, the material for the underlying film 2 may be a high-melting point material that has a strong out-of-plane orientation allowing the underlying film 2 to be wet with SiO₂ and that can suppress the grain growth of the underlying film 2, for example, metals, such as Ti, Hf, Mo, Nb, Ta, V, W, and Zr (region II in FIG. 3), as shown in FIG. 3.

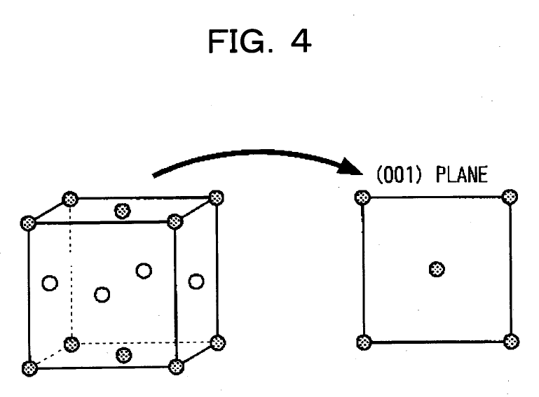

Furthermore, the material is selected such that a nanoparticle, for example, an FePt magnetic nanoparticle can have an fct structure having an out-of-plane c-axis orientation. That is, a plane having a fourfold symmetry is necessary, as illustrated in FIG. 4. In this regard, a representative crystal structure has the closest packed face and the symmetry of fcc (111) with a sixfold symmetry, bcc (110) with a twofold symmetry, and hcp (0001) with a sixfold symmetry. However, all of these do not match the FePt magnetic nanoparticle. On the other hand, a NaCl-type XY crystal has a closest packed face of a (100) plane with a fourfold symmetry and matches the FePt magnetic nanoparticle. Thus, a NaCl-type crystal, for example, a nitride such as TiN, VN, ZrN, NbN, HfN, TaN, or ThN, or an oxide such as MgO, CaO, SrO, or BaO can be used.

(3) Then, as illustrated in FIG. 1(c-1) (cross-sectional view) and FIG. 1(c-2) (plan view), a nanoparticle material 4, for example, an FePt magnetic material is deposited at high temperature by sputtering.

A nanoparticle 4 can be grown by local epitaxy on each underlying microcrystalline film 2 by designing the underlying microcrystalline film 2 and the nanoparticle material 4 to have a comparable lattice constant. This is because the in-plane orientation is different between microcrystals and a nanoparticle is difficult to grow over multiple microcrystals. Thus, one nanoparticle grows on one underlying microcrystal and has an equilibrium structure in a very small reaction field 3. Since the underlying microcrystal has an out-of-plane orientation, the nanoparticle also has an out-of-plane orientation.

Thus, according to this method, a microcrystalline film that can grow epitaxially to an objective material can be grown from any substrate, including an inexpensive glass. Then, an out-of-plane oriented nanoparticle having a controlled size can be formed on the microcrystalline film with the objective material.

A perpendicular magnetic recording medium will be described below as an example of specific applications.

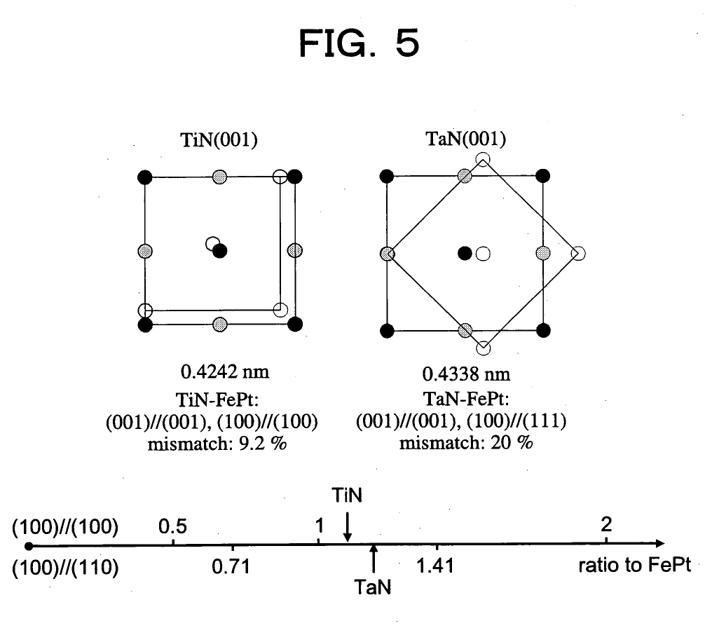

An FePt alloy was used. A NaCl-type metal nitride TiN or TaN as illustrated in FIG. 5 was used as an underlying material. For TiN having a lattice constant x of 0.4242 nm, the lattice mismatch of TiN—FePt: (001)//(001), (100)//(100) is +9.2% and TiN satisfies the relationship of c<a<x˜1.1a. Thus, TiN is preferred as an underlying material. BaO has the relationship of x˜√2× a and can be grown epitaxially when shifted by 45° (not shown). Thus, BaO is also used as an underlying material.

Accordingly, the present invention can achieve the following effects with a common apparatus at low cost, that is, using a sputtering apparatus: (1) an fct crystal structure, (2) a c-axis orientation, (3) a nanoparticle size of about 10 nm, (4) an interval of several nanometers between nanoparticles, (5) less than several nanometers of entire bumps and dips, and (6) uniformity in a large area.

These are described below with reference to specific examples.

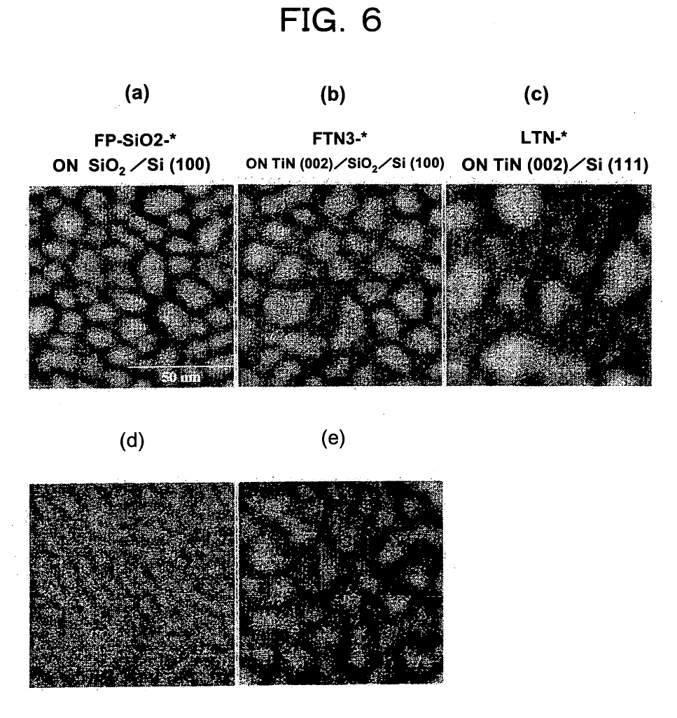

FIG. 6 is electron micrographs showing specific examples of the formation of FePt magnetic nanoparticles on an underlying film.

FP—SiO₂ [FePt magnetic nanoparticles were formed on SiO₂/Si (100)] [see FIG. 6(a)] was treated at 800° C. at the amount of deposited FePt equivalent to a thickness of 2 nm. The same FP—SiO₂ [see FIG. 6(d)] was treated at 600° C. at the amount of deposited FePt equivalent to a thickness of 2 nm. FTN3 [FePt magnetic nanoparticles were formed on TiN (002)/SiO₂/Si (100)] [see FIG. 6(b)] was treated at 800° C. at the amount of deposited FePt equivalent to a thickness of 2 nm. The same FTN3 [see FIG. 6(e)] was treated at 600° C. at the amount of deposited FePt equivalent to a thickness of 2 nm. LTN [FePt magnetic nanoparticles were formed on TiN (002)/Si (111)] [see FIG. 6(c)] was treated at 800° C. at the amount of deposited FePt equivalent to a thickness of 2 nm. Since a high-melting point material as an underlying material and FePt nanoparticles were used, the processing temperature can be 200° C. to 1600° C. In particular, excellent FePt magnetic nanoparticles can be formed at 300° C. to 800° C.

The field-emission scanning electron microscope (FESEM) photographs of FP—SiO₂ [see FIGS. 6(a) and 6(d)] and FTN3 [see FIGS. 6(b) and 6(e)] show that use of TiN permits consistent control of the number density of FePt (the number density corresponding to the underlying TiN crystallite size), regardless of the substrate temperature.

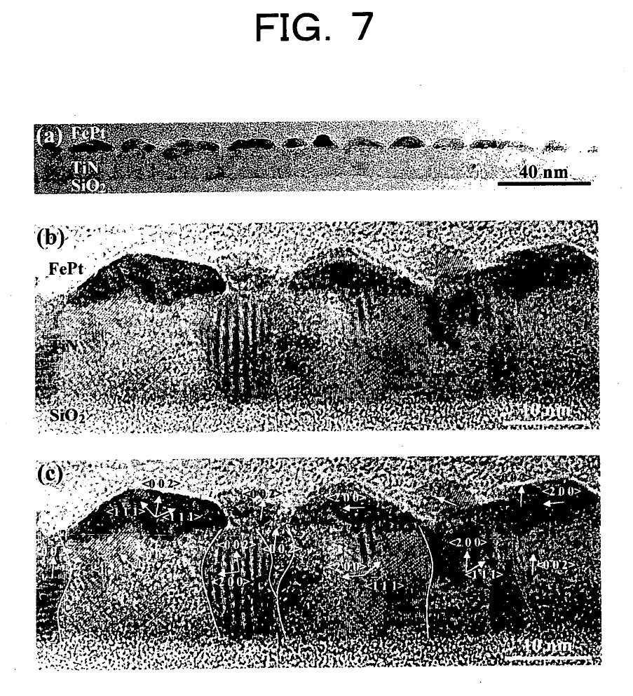

FIG. 7 are cross-sectional transmission electron microscope images of a sample prepared by forming a TiN film having a thickness of 13 nm at 600° C. on a thermally-oxidized film-coated Si substrate and then forming an FePt film having a reduced thickness of 1.4 nm on the TiN film at 700° C.

FIG. 7(a) shows that discrete FePt nanoparticles having diameters of about 10 nm are formed at high density. FIG. 7(b) is an enlarged view of FIG. 7(a). FIG. 7(c) is an analytical result of the crystal structure.

FIG. 7(c) shows that the TiN underlying microcrystals have crystal grain sizes of about 10 nm and have an out-of-plane (200) orientation. FePt nanoparticles on the TiN underlying microcrystals have an fct structure. Many FePt nanoparticles have an out-of-plane (001) orientation, that is, a c-axis orientation. Furthermore, one FePt nanoparticle is formed on one TiN underlying microcrystal.

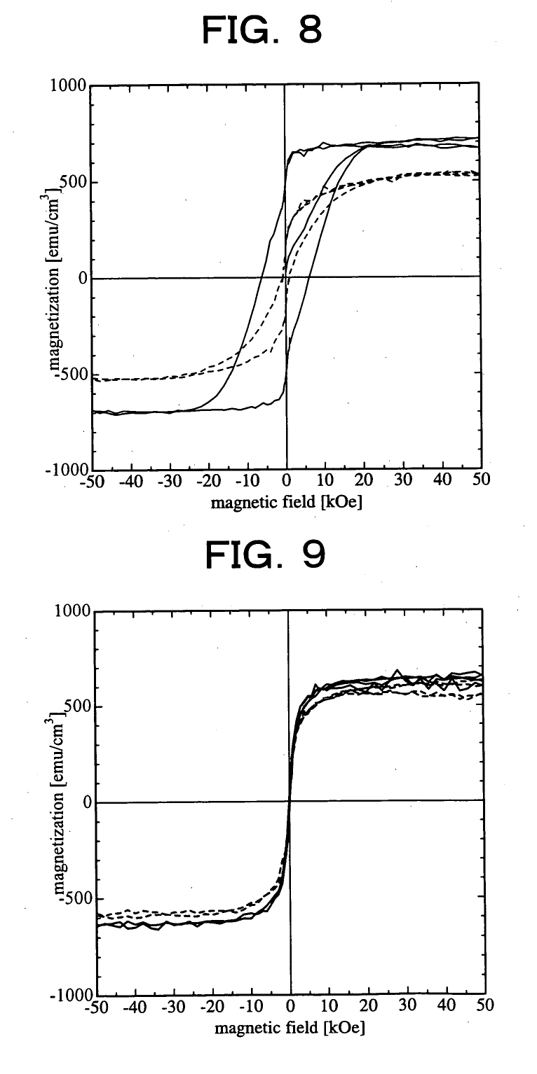

FIG. 8 shows an evaluation result of the magnetic characteristics of the sample with a superconducting quantum interference device (SQUID). The solid line indicates the measurements in a direction perpendicular to a substrate. The broken line indicates the measurements in a direction parallel to the substrate. The results showed that the sample has a coercive force of 6.2 kOe in a direction perpendicular to a substrate and 0.8 kOe in the in-plane direction at normal temperature, indicating a strong out-of-plane magnetic anisotropy. A high-density array of FePt nanoparticles having such magnetic characteristics and diameters of about 10 nm is a promising perpendicular magnetic recording medium.

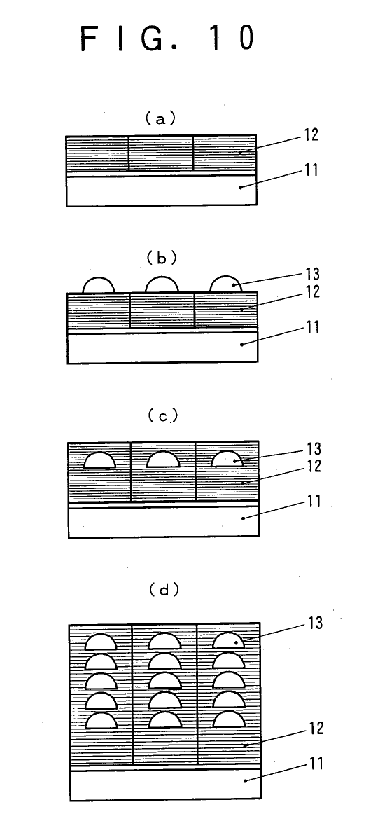

FIG. 9 shows an evaluation result of the magnetic characteristics of a comparative sample with a superconducting quantum interference device (SQUID). The comparative sample was prepared by forming an FePt film having a reduced thickness of 1.4 nm at 700° C. on a thermally-oxidized film-coated Si substrate. A TiN underlying microcrystalline film was not formed. As is apparent from this figure, no hysteresis was observed in both the out-of-plane direction and the in-plane direction. Scanning electron microscopy had shown that the size of an FePt nanoparticle was not controlled on SiO₂. This was due to the superparamagnetism. Furthermore, an X-ray diffraction analysis had shown that the sample had no crystalline orientation. Even if a nanoparticle that has a coercive force and has a diameter of about 10 nm is formed, it is impossible for the nanoparticle to have an anisotropy in a direction perpendicular to a substrate without using a TiN underlying microcrystalline film of the present invention.

In most of conventional techniques, when nanoparticles are heated to a high temperature of 350° C. to 800° C. to achieve an fct crystal structure, the nanoparticles are aggregated easily and cannot retain the particle size of about 10 nm.

According to the present invention, use of a high-melting point material as an underlying material prevents the grain growth in an underlying microcrystalline film, allowing the formation of a nanoparticle on each individual microcrystal. Thus, the nanoparticle can retain a particle size of about 10 nm. Thus, with respect to a hard disk, the present invention increases the recording density 100 times that of existing hard disks (1 bit per 100 nm square=10 Gbit/cm²). With respect to other nanodevices as well, the present invention can provide a strong general-purpose nanoparticle.

The present invention can be applied to a CoPt magnetic nanoparticle as well as an FePt magnetic nanoparticle.

In particular, indispensable conditions for the perpendicular magnetic recording medium in a hard disk involve (1) an fct phase (L1₀ structure), (2) a c-axis orientation (out-of-plane or in-plane), (3) a grain or crystallite size of 3 to 10 nm, (4) a structure with a small interfacial influence (error prevention), (5) less than several nanometers of bumps and dips (read and write with a magnetic head), and (6) a uniform nanoparticle array in a large area (storage area of about inches). The present invention can satisfy these conditions.

FIG. 10 is a manufacturing process drawing of a laminated nanoparticle device according to a second embodiment of the present invention.

First, a process similar to that illustrated in FIG. 1 is used.

(1) As illustrated in FIG. 10(a), a Si substrate or a SiO₂-coated Si substrate 11 is prepared. A glass substrate is preferred because of its low price. Then, a film (underlying film) 12 of a high-melting point material, for example, a TiN material is formed on the SiO₂-coated Si substrate 11 by sputtering. The high-melting point material, for example, TiN characteristically grows to several nanometers even near room temperature but does not grow excessively even at high temperature. The high-melting point material is oriented in the out-of-plane direction to have a minimum surface energy and is not oriented in the in-plane direction. The resulting film (underlying microcrystalline film) 12 is used as an underlying film.

(2) Then, as illustrated in FIG. 10(b), a nanoparticle material 13, for example, an FePt magnetic material is deposited at high temperature by sputtering.

A nanoparticle 13 can be grown by local epitaxy on each underlying microcrystalline film 12 by designing the underlying microcrystalline film 12 and the nanoparticle material 13 to have a comparable lattice constant. This is because the in-plane orientation is different between microcrystals and a nanoparticle is difficult to grow over multiple microcrystals. Thus, one nanoparticle grows on one underlying microcrystal and has an equilibrium structure in a very small reaction field. Since the underlying microcrystal has an out-of-plane orientation, the nanoparticle also has an out-of-plane orientation.

Thus, according to this method, a microcrystalline film that can grow epitaxially to an objective material can be grown from any substrate, including an inexpensive glass. Then, an out-of-plane oriented nanoparticle having a controlled size can be formed on the microcrystalline film with the objective material.

(3) Then, as illustrated in FIG. 10(c), the underlying microcrystalline film 12 is formed on the nanoparticle by sputtering [a process similar to that in FIG. 10(a)].

(4) Then, as illustrated in FIG. 10(d), a nanoparticle material 13, for example, an FePt magnetic material is deposited on the underlying microcrystalline film 12 at high temperature by sputtering. These steps are repeated.

In this manner, a template crystal of the underlying microcrystalline film is non-epitaxially grown on the substrate to form a template for a nanoparticle. Then, nanoparticles and underlying microcrystalline films are alternately stacked and are repeatedly grown by local epitaxy in a direction perpendicular to the substrate.

Accordingly, longitudinally packaged nanoparticles having a controlled size, number density, interval, and orientation can be formed. Thus, when the longitudinally packaged nanoparticles are used as a magnetic recording medium, the volume of nanoparticles can be increased perpendicularly, and the magnetic error, for example, due to thermal fluctuations can be reduced.

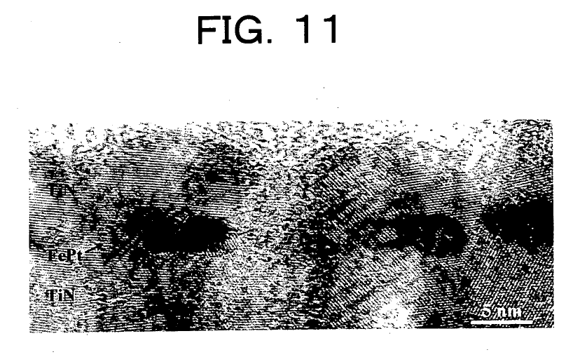

FIG. 11 is a cross-sectional transmission electron microscope image of a sample prepared by forming a TiN underlying microcrystalline film on a thermally-oxidized film-coated Si substrate, then forming an FePt nanoparticle on the TiN underlying microcrystalline film, and then forming another TiN underlying microcrystalline film on the FePt nanoparticle. This image shows that the FePt nanoparticle and the TiN underlying microcrystalline film are formed by local epitaxy on each crystal grain in the TiN underlying microcrystalline film. The same structure as the TiN underlying microcrystalline film is provided on the FePt nanoparticle. In the same manner, FePt nanoparticles can be stacked by sequentially providing FePt and TiN while the c-axis orientation and the in-plane size of about 10 nm are maintained.

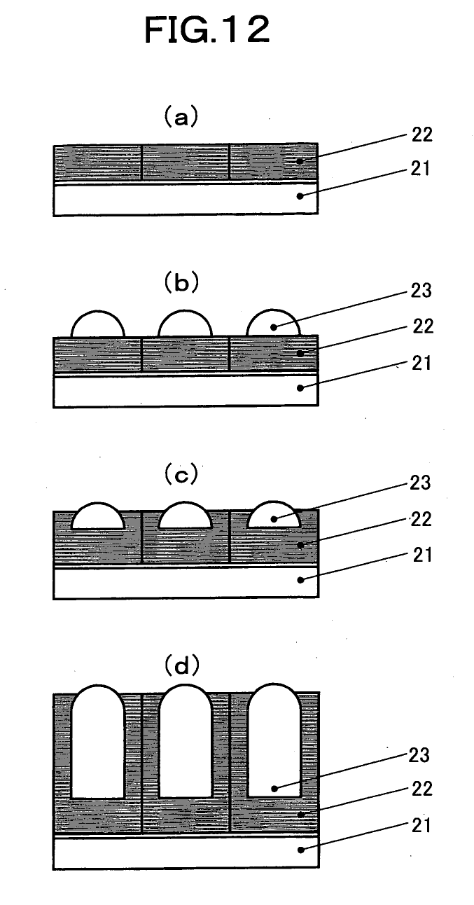

FIG. 12 is a manufacturing process drawing of a nanoparticle device composed of longitudinal FePt nanoparticles according to a third embodiment of the present invention.

(1) As illustrated in FIG. 12(a), a Si substrate or a SiO₂-coated Si substrate 21 is prepared. A glass substrate is preferred because of its low price. Then, a film (underlying film) 22 of a high-melting point material, for example, a TiN material is formed on the SiO₂-coated Si substrate 21 by sputtering. The high-melting point material, for example, TiN characteristically grows to several nanometers even near room temperature but does not grow excessively even at high temperature. The high-melting point material is oriented in the out-of-plane direction to have a minimum surface energy and is not oriented in the in-plane direction. The resulting film (underlying microcrystalline film) 22 is used as an underlying film.

(2) Then, as illustrated in FIG. 12(b), a nanoparticle material 23, for example, an FePt magnetic material is deposited at high temperature by sputtering.

A nanoparticle 23 can be grown by local epitaxy on each underlying microcrystalline film 22 by designing the underlying microcrystalline film 22 and the nanoparticle material 23 to have a comparable lattice constant. This is because the in-plane orientation is different between microcrystals and a nanoparticle is difficult to grow over multiple microcrystals. Thus, one nanoparticle grows on one underlying microcrystal and has an equilibrium structure in a very small reaction field. Since the underlying microcrystal has an out-of-plane orientation, the nanoparticle also has an out-of-plane orientation.

Thus, according to this method, a microcrystalline film that can grow epitaxially to an objective material can be grown from any substrate, including an inexpensive glass. Then, an out-of-plane oriented nanoparticle having a controlled size can be formed on the microcrystalline film with the objective material.

(3) Then, as illustrated in FIG. 12(c), another underlying microcrystalline film 22 is formed on the nanoparticle by sputtering [a process similar to that in FIG. 12(a)]. By decreasing the amount of the underlying microcrystal 22 to be deposited, the surface of the nanoparticle 23 can be exposed at the surface of the underlying microcrystal 22 while the underlying microcrystal 22 and the nanoparticle 23 are formed by local epitaxy.

(4) Then, as illustrated in FIG. 12(d), the nanoparticle material 23 and the underlying microcrystalline film material 22 are sequentially stacked at high temperature by sputtering. The nanoparticle material 23 grows on the nanoparticle and the underlying microcrystalline material 22 grows on the underlying microcrystal. This produces a longitudinally oriented nanoparticle material 23.

In this manner, a template crystal of the underlying microcrystalline film is non-epitaxially grown on the substrate to form a template for a nanoparticle. Then, nanoparticles and underlying microcrystalline films are alternately stacked and are repeatedly grown by local epitaxy in a direction perpendicular to the substrate. Furthermore, the nanoparticle and the underlying microcrystal may be stacked simultaneously and may be phase-separated spontaneously.

Accordingly, longitudinally oriented nanoparticles having a controlled size, number density, interval, and orientation can be formed. Thus, when the longitudinally oriented nanoparticles are used as a magnetic recording medium, the volume of nanoparticles can be increased perpendicularly, and the magnetic error, for example, due to thermal fluctuations can be reduced.

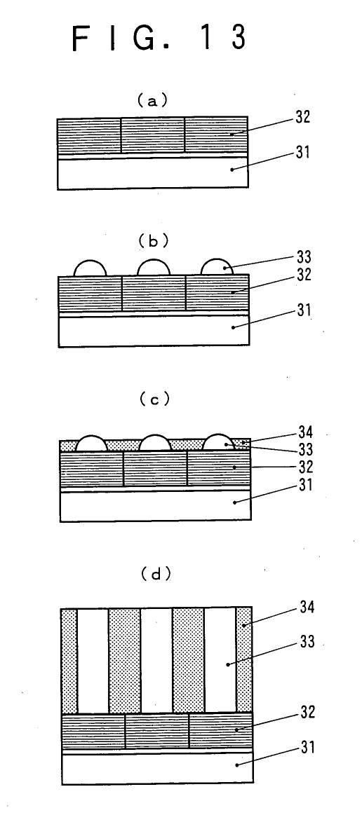

FIG. 13 is a manufacturing process drawing of a nanoparticle device composed of longitudinally oriented nanoparticles according to a fourth embodiment of the present invention.

A process similar to that illustrated in FIG. 1 is used.

(1) As illustrated in FIG. 13(a), a Si substrate or a SiO₂-coated Si substrate 31 is prepared. A glass substrate is preferred because of its low price. Then, a film (underlying film) 32 of a high-melting point material, for example, a TiN material is formed on the SiO₂-coated Si substrate 31 by sputtering. The high-melting point material, for example, TiN characteristically grows to several nanometers even near room temperature but does not grow excessively even at high temperature. The high-melting point material is oriented in the out-of-plane direction to have a minimum surface energy and is not oriented in the in-plane direction. The resulting film (underlying microcrystalline film) 32 is used as an underlying film.

(2) Then, as illustrated in FIG. 13(b), a nanoparticle material 33, for example, an FePt magnetic material is deposited at high temperature by sputtering.

A nanoparticle material 33 can be grown by local epitaxy on each underlying microcrystalline film 32 by designing the underlying microcrystalline film 32 and the nanoparticle material 33 to have a comparable lattice constant. This is because the in-plane orientation is different between microcrystals and a nanoparticle is difficult to grow over multiple microcrystals. Thus, one nanoparticle grows on one underlying microcrystal and has an equilibrium structure in a very small reaction field. Since the underlying microcrystal has an out-of-plane orientation, the nanoparticle also has an out-of-plane orientation.

(3) Then, as illustrated in FIG. 13(c), a matrix material (for example, an amorphous material or a metal or alloy material) 34 different from a component of the nanoparticle is deposited on the nanoparticle material 33. An amorphous material containing at least one element selected from the group consisting of C, N, O, Al, and Si, or a metal or alloy material containing Ti, Fe, Co, Cr, and/or Pt is suitable for the matrix material 34. Advantageously, these materials move selectively to a grain boundary in a template polycrystalline film.

(4) Then, as illustrated in FIG. 13(d), a nanoparticle material 33, for example, an FePt magnetic material is deposited on the matrix material 34 at high temperature by sputtering. These steps are repeated. The nanoparticle material 33 and the matrix material 34 may be deposited simultaneously.

Thus, the deposited matrix material different from a component of the nanoparticle to be phase-separated can fill the space between nanoparticles and thereby prevent the nanoparticles from melting into each other in the in-plane direction, allowing the nanoparticles to grow in a direction perpendicular to a substrate.

Since an underlying microcrystalline film is formed by non-epitaxial growth, any substrate can be used. Furthermore, when it is desired that an underlying microcrystalline layer be formed on a particular crystalline layer, any underlying microcrystalline layer can be formed, without the influence of the crystal structure of the particular crystalline layer, by depositing a thin amorphous material on the particular crystalline layer and forming the underlying microcrystalline layer on the thin amorphous material. Since the underlying microcrystalline layer has no in-plane orientation, a nanoparticle of interest on the underlying microcrystalline layer is difficult to grow over a plurality of underlying microcrystals. Thus, one nanoparticle grows on one underlying microcrystal by local epitaxy. In other words, the number density of nanoparticles of interest can be controlled by the number density of crystallites in an underlying microcrystal, and the out-of-plane orientation of the nanoparticle of interest can be controlled by the out-of-plane orientation of the underlying microcrystal. In addition, the size of individual nanoparticles and the interval between nanoparticles can be controlled by adjusting the amount of nanoparticles of interest to be deposited. Furthermore, a matrix material filling the space between nanoparticles prevents the nanoparticles from melting into each other. Continuous deposition of the nanoparticle material and the matrix material allows the nanoparticles to grow in a direction perpendicular to a substrate. Thus, the present invention can satisfy seemingly conflicting requirements of a higher surface density of nanoparticles and an increased volume of individual nanoparticles.

Furthermore, the thin film structure described above can be formed by many conventional deposition methods, such as sputtering, without impairing uniformity in a large area and a reduction in cost.

While a nanoparticle device having a structure of an FePt nanoparticle/a TiN underlying microcrystalline film/a substrate is described in the embodiments described above, the following structures are also possible.

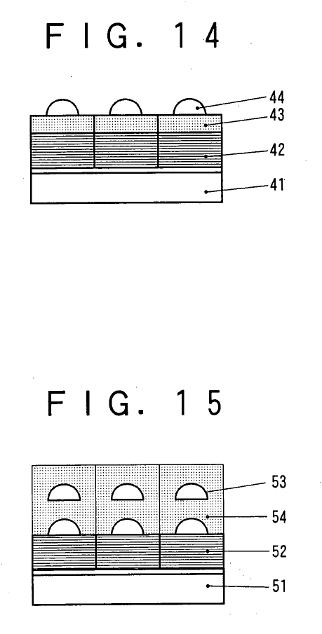

FIG. 14 is a schematic view of the structure of a nanoparticle device according to a fifth embodiment of the present invention. As illustrated in this figure, another film (microcrystalline film) may be disposed between the FePt nanoparticle and the TiN underlying microcrystalline film described above. For example, the structure may be an FePt nanoparticle 44/an Fe microcrystalline film 43/a TiN underlying microcrystalline film 42/a SiO₂-coated Si substrate 41.

FIG. 15 is a schematic view of the structure of a nanoparticle device including stacked FePt nanoparticles according to a sixth embodiment of the present invention. As illustrated in this figure, in the stacked structure, the second and higher microcrystal layers are not necessarily the same material as the first underlying microcrystalline film (TiN). For example, the structure may be an Fe microcrystalline film 54/an FePt nanoparticle 53/an Fe microcrystalline film 54/an FePt nanoparticle 53/a TiN underlying microcrystalline film 52/a SiO₂-coated Si substrate 51.

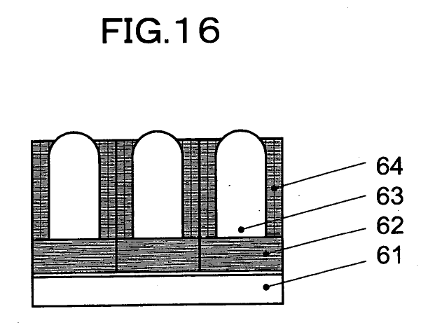

FIG. 16 is a schematic view of the structure of a nanoparticle device including longitudinally oriented FePt nanoparticles according to a seventh embodiment of the present invention. As illustrated in this figure, a microcrystal that grows by local epitaxy on a nanoparticle is not necessarily the same material as the first underlying microcrystalline film (TiN). For example, the structure may by an Fe microcrystal 64/an FePt nanoparticle 63/a TiN underlying microcrystalline film 62/a SiO₂-coated Si substrate 61.

Furthermore, while the Fe microcrystal is used in these embodiments (FIGS. 14 to 16 and their description), the microcrystal is not limited to this and may be any microcrystal other than Fe.

Furthermore, the present invention is not limited to the embodiments described above and encompasses the following.

[A] A nanoparticle device includes a monolayer or multilayer substrate, an out-of-plane oriented underlying microcrystalline film deposited on this substrate and having no in-plane orientation, and a nanoparticle formed by local epitaxy on each underlying microcrystal in the underlying microcrystalline film.

[B] A nanoparticle device includes a monolayer or multilayer substrate, an out-of-plane oriented underlying microcrystalline film deposited on this substrate and having no in-plane orientation, a nanoparticle formed by local epitaxy on each underlying microcrystal in the underlying microcrystalline film, and stacked nanoparticles prepared by repeated formation of the underlying microcrystalline films and the nanoparticles in a direction perpendicular to the substrate.

[C] A nanoparticle device includes a monolayer or multilayer substrate, an out-of-plane oriented underlying microcrystalline film deposited on this substrate and having no in-plane orientation, a longitudinally oriented nanoparticle formed by local epitaxy on each underlying microcrystal in the underlying microcrystalline film, and a microcrystalline material formed by local epitaxy on each nanoparticle and surrounding the nanoparticle.

[D] A nanoparticle device includes a monolayer or multilayer substrate, an out-of-plane oriented underlying microcrystalline film deposited on this substrate and having no in-plane orientation, a longitudinally oriented nanoparticle formed by local epitaxy on each underlying microcrystal in the underlying microcrystalline film, and a material that fills the space among the nanoparticles and has a different composition from the nanoparticle.

[E] The multilayer substrate is formed of a magnetic control layer and/or a structure control layer. The structure control layer is not epitaxial with microcrystals of the underlying microcrystalline film.

The layer that is not epitaxial with microcrystals of the underlying microcrystalline film is an amorphous substance, a metal, or an alloy. The metal or alloy may be Ti, Fe, Co, Cr, and/or Pt. The amorphous substance contains at least one element selected from the group consisting of C, N, O, Al, and Si.

The layer that is not epitaxial with microcrystals of the underlying microcrystalline film is formed of a crystal with a large lattice mismatch. Furthermore, the layer that is not epitaxial with microcrystals of the underlying microcrystalline film is formed of a crystal having a disordered surface structure.

[F] The underlying microcrystalline film is formed of a high-melting point material. The high-melting point material is a NaCl-type crystal. The NaCl-type crystal is a nitride. The nitride is TiN, VN, ZrN, NbN, HfN, TaN, or ThN.

Furthermore, the NaCl-type crystal is an oxide. The oxide is MgO, CaO, SrO, or BaO.

Furthermore, the high-melting point material includes Ti, V, Zr, Nb, Mo, Hf, Ta, and/or W.

[G] The nanoparticle is formed of a magnetic recording material. The magnetic recording material is an alloy having an L1₀ structure. Furthermore, the alloy having an L1₀ structure is an fct transition metal/noble metal alloy. The fct transition metal/noble metal alloy is FePt or CoPt.

[H] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, and using the surface of each underlying microcrystal in the underlying microcrystalline film as a very small space for local epitaxial growth on the underlying microcrystal to produce a nanoparticle in the very small space.

[I] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, and alternately depositing the nanoparticle material and a material, including the underlying material, that has a comparable lattice constant to the nanoparticle material on the nanoparticle in a direction perpendicular to the substrate to stack the nanoparticles by local epitaxial growth.

[J] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, depositing a material that has a different composition from the nanoparticle and has a comparable lattice constant to the nanoparticles, and segregating the material to be epitaxial with the nanoparticle, and simultaneously or alternately depositing the nanoparticle material and a material that has a different composition from the nanoparticle and has a comparable lattice constant to the nanoparticle to grow the nanoparticle in a direction perpendicular to the substrate.

[K] A method for producing a nanoparticle device includes the steps of forming an out-of-plane oriented underlying microcrystalline film having no in-plane orientation on a monolayer or multilayer substrate by non-epitaxial growth, matching the lattice constant of a nanoparticle material with that of a material for this underlying microcrystalline film, using the surface of each underlying microcrystal in the underlying microcrystalline film as a very small space for local epitaxial growth on the underlying microcrystal to produce a nanoparticle in the very small space, depositing an amorphous material to be distributed by segregation among the nanoparticles, and simultaneously or alternately depositing the nanoparticle material and a material having a different composition from the nanoparticle to grow the nanoparticle in a direction perpendicular to the substrate.

[L] The grain growth in the underlying microcrystalline film is suppressed and the underlying microcrystalline film is out-of-plane oriented at a minimum surface energy, a minimum chemical etching rate, a minimum plasma irradiation damage, a minimum stress, or a maximum growth rate.

[M] The nanoparticle is an FePt- or a CoPt-based magnetic nanoparticle.

[N] In the method for producing a nanoparticle device, the local epitaxial growth is performed by sputtering while the substrate is heated at 200° C. to 1600° C.

[O] The method for producing a nanoparticle device, wherein the local epitaxial growth is performed by forming the underlying microcrystalline film and then depositing FePt or CoPt without exposure to the atmosphere.

[P] The method for producing a nanoparticle device, wherein the underlying microcrystalline film is formed on the substrate and then FePt or CoPt is deposited and is annealed at 200° C. to 1600° C. to perform local epitaxial growth.

[Q] The method for producing a nanoparticle device, wherein after the formation of the underlying microcrystalline film FePt or CoPt is deposited without exposure to the atmosphere and is then annealed to perform local epitaxial growth.

[R] The crystal structure of the nanoparticle is an fct structure and at least 90% of the c-axis of the crystal of the nanoparticle becomes oriented in a direction perpendicular to the underlying microcrystalline film.

Various modifications are possible on the basis of the gist of the present invention and are not excluded from the scope of the present invention.

### INDUSTRIAL APPLICABILITY

A nanoparticle device and a method for producing the nanoparticle device according to the present invention, in which the process itself is a dry process, can be applied to microdevices including nanoparticles, such as a semiconductor quantum dot device, and is particularly suitable for a hard disk perpendicular magnetic recording medium in which a high-density array is indispensable.

1. A nanoparticle device comprising:
(a) a monolayer or multilayer substrate;
(b) an out-of-plane oriented underlying microcrystalline film deposited on the substrate and having no in-plane orientation; and
(c) a nanoparticle formed by local epitaxy on each underlying microcrystal in the underlying microcrystalline film.

2. A nanoparticle device comprising:
(a) a monolayer or multilayer substrate;
(b) an out-of-plane oriented underlying microcrystalline film deposited on the substrate and having no in-plane orientation;
(c) a microcrystalline film composed of microcrystals formed by local epitaxy on their respective underlying microcrystals in the underlying microcrystalline film; and
(d) a nanoparticle formed by local epitaxy on each microcrystal in the microcrystalline film.

3. A nanoparticle device comprising:
(a) a monolayer or multilayer substrate;
(b) an out-of-plane oriented underlying microcrystalline film deposited on the substrate and having no in-plane orientation;
(c) a nanoparticle formed by local epitaxy on each underlying microcrystal in the underlying microcrystalline film;
(d) a microcrystalline film formed by local epitaxy on each nanoparticle; and
(e) stacked nanoparticles formed by repeated local epitaxy of the nanoparticles and the microcrystalline films in a direction perpendicular to the substrate.

4. A nanoparticle device comprising:
(a) a monolayer or multilayer substrate;
(b) an out-of-plane oriented underlying microcrystalline film deposited on the substrate and having no in-plane orientation;
(c) vertically elongated nanoparticles formed by local epitaxy on each underlying microcrystal in the underlying microcrystalline film; and
(d) a microcrystalline material formed by local epitaxy on each nanoparticle and surrounding the nanoparticle.

5. A nanoparticle device comprising:
(a) a monolayer or multilayer substrate;
(b) an out-of-plane oriented underlying microcrystalline film deposited on the substrate and having no in-plane orientation;
(c) vertically elongated nanoparticles formed by local epitaxy on each underlying microcrystal in the underlying microcrystalline film; and
(d) a material that fills the space among the nanoparticles and has a different composition from the nanoparticle.

6. The nanoparticle device according to claim 3, 4, or 5, further comprising a microcrystalline film that is disposed between the underlying microcrystalline film and the nanoparticle and is composed of microcrystals formed by local epitaxy on their respective underlying microcrystals in the underlying microcrystalline film.

7. The nanoparticle device according to any one of claims 1 to 6, the multilayer substrate is formed of a magnetic control layer and/or a structure control layer.

8. The nanoparticle device according to claim 7, wherein the structure control layer is not epitaxial with microcrystals of the underlying microcrystalline film.

9. The nanoparticle device according to claim 8, wherein the layer that is not epitaxial with microcrystals of the underlying microcrystalline film is formed of an amorphous substance.

10. The nanoparticle device according to claim 9, wherein the amorphous substance contains at least one element selected from the group consisting of C, N, O, Al, and Si.

11. The nanoparticle device according to claim 8, wherein the layer that is not epitaxial with microcrystals of the underlying microcrystalline film is formed of a crystal with a large lattice mismatch.

12. The nanoparticle device according to claim 8, wherein the layer that is not epitaxial with microcrystals of the underlying microcrystalline film is formed of a crystal having a disordered surface structure.

13. The nanoparticle device according to any one of claims 1 to 6, wherein the underlying microcrystalline film is formed of a high-melting point material.

14. The nanoparticle device according to claim 13, wherein the high-melting point material is a NaCl-type crystal.

15. The nanoparticle device according to claim 14, wherein the NaCl-type crystal is a nitride.

16. The nanoparticle device according to claim 15, wherein the nitride is TiN, VN, ZrN, NbN, HfN, TaN, or ThN.

17. The nanoparticle device according to claim 13, wherein the NaCl-type crystal is an oxide.

18. The nanoparticle device according to claim 17, wherein the oxide is MgO, CaO, SrO, or BaO.

19. The nanoparticle device according to claim 13, wherein the high-melting point material comprises Ti, V, Zr, Nb, Mo, Hf, Ta, and/or W.

20. The nanoparticle device according to any one of claims 1 to 6, wherein the nanoparticle is formed of a magnetic recording material.

21. The nanoparticle device according to claim 20, wherein the magnetic recording material is an alloy having an L1₀ structure.

22. The nanoparticle device according to claim 21, wherein the alloy having an L1₀ structure is an fct transition metal/noble metal alloy.

23. The nanoparticle device according to claim 22, wherein the fct transition metal/noble metal alloy is FePt or CoPt.

24. A nanoparticle device in which a microcrystal formed by local epitaxy on each nanoparticle according to claim 3 or 4 is formed of a metal or alloy material containing Ti, Fe, Co, Cr, Ag, and/or Pt.

25. The nanoparticle device according to claim 5, wherein the material different from a component of the nanoparticle is an amorphous material containing at least one element selected from the group consisting of C, N, O, Al, and Si.

26. The nanoparticle device according to claim 5, wherein the material different from a component of the nanoparticle is a metal or alloy material containing Ti, Fe, Co, Cr, Ag, and/or Pt.

27. A method for producing a nanoparticle device, comprising the steps of:
(a) forming an out-of-plane oriented underlying microcrystalline film having no in-plane orientation on a monolayer or multilayer substrate by non-epitaxial growth; and
(b) matching the lattice constant of a nanoparticle material with that of a material for the underlying microcrystalline film and using the surface of each underlying microcrystal in the underlying microcrystalline film as a very small space for local epitaxial growth on the underlying microcrystal to produce a nanoparticle in the very small space.

28. A method for producing a nanoparticle device, comprising the steps of:
(a) forming an out-of-plane oriented underlying microcrystalline film having no in-plane orientation on a monolayer or multilayer substrate by non-epitaxial growth;
(b) matching the lattice constant of a nanoparticle material with that of a material for the underlying microcrystalline film and using the surface of each underlying microcrystal in the underlying microcrystalline film as a very small space for local epitaxial growth on the underlying microcrystal to produce a nanoparticle in the very small space; and
(c) alternately depositing the nanoparticle material and a material, including the underlying material, that has a comparable lattice constant to the nanoparticle material on the nanoparticle in a direction perpendicular to the substrate to stack the nanoparticles by local epitaxial growth.

29. A method for producing a nanoparticle device, comprising the steps of:
(a) forming an out-of-plane oriented underlying microcrystalline film having no in-plane orientation on a monolayer or multilayer substrate by non-epitaxial growth;
(b) matching the lattice constant of a nanoparticle material with that of a material for the underlying microcrystalline film and using the surface of each underlying microcrystal in the underlying microcrystalline film as a very small space for local epitaxial growth on the underlying microcrystal to produce a nanoparticle in the very small space;
(c) depositing a material that has a different composition from the nanoparticle and has a comparable lattice constant to the nanoparticles, and segregating the material to be epitaxial with the nanoparticle; and
(d) simultaneously or alternately depositing the nanoparticle material and a material that has a different composition from the nanoparticle and has a comparable lattice constant to the nanoparticle to grow the nanoparticle in a direction perpendicular to the substrate.

30. A method for producing a nanoparticle device, comprising the steps of:
(a) forming an out-of-plane oriented underlying microcrystalline film having no in-plane orientation on a monolayer or multilayer substrate by non-epitaxial growth;
(b) matching the lattice constant of a nanoparticle material with that of a material for the underlying microcrystalline film and using the surface of each underlying microcrystal in the underlying microcrystalline film as a very small space for local epitaxial growth on the underlying microcrystal to produce a nanoparticle in the very small space;
(c) depositing a material having a different composition from the nanoparticle to be distributed by segregation among the nanoparticles; and
(d) simultaneously or alternately depositing the nanoparticle material and the material having a different composition from the nanoparticle to grow the nanoparticle in a direction perpendicular to the substrate.

31. The method for producing a nanoparticle device according to any one of claims 27 to 30, further comprising the step of forming a microcrystalline film composed of microcrystals formed by local epitaxy on their respective underlying microcrystals in the underlying microcrystalline film between the step (a) and the step (b).

32. The method for producing a nanoparticle device according to any one of claims 27 to 31, wherein the grain growth in the underlying microcrystalline film is suppressed and the underlying microcrystalline film is out-of-plane oriented at
(a) a minimum surface energy,
(b) a minimum chemical etching rate,
(c) a minimum plasma irradiation damage,
(d) a minimum stress, or
(e) a maximum growth rate.

33. The method for producing a nanoparticle device according to any one of claims 27 to 32, wherein the nanoparticle is an FePt-based magnetic nanoparticle.

34. The method for producing a nanoparticle device according to any one of claims 27 to 32, wherein the nanoparticle is a CoPt-based magnetic nanoparticle.

35. The method for producing a nanoparticle device according to claim 33 or 34, wherein the local epitaxial growth is performed while the substrate is heated at 200° C. to 1600° C.

36. The method for producing a nanoparticle device according to claim 35, wherein the local epitaxial growth is performed by forming the underlying microcrystalline film and then depositing FePt or CoPt without exposure to the atmosphere.

37. The method for producing a nanoparticle device according to claim 33 or 34, wherein the underlying microcrystalline film is deposited on the substrate and then FePt or CoPt is deposited and is annealed at 200° C. to 1600° C. to perform local epitaxial growth.

38. The method for producing a nanoparticle device according to claim 37, wherein after the formation of the underlying microcrystalline film FePt or CoPt is deposited without exposure to the atmosphere and is annealed to perform local epitaxial growth.

39. The method for producing a nanoparticle device according to any one of claims 27 to 38, wherein the crystal structure of the nanoparticle is an fct structure and at least 90% of the c-axis of the crystal of the nanoparticle becomes oriented in a direction perpendicular to the underlying microcrystalline film.
